(19) United States
(12) Patent Application Publication
(10) Pub. No.: US 2018/0031849 A1
(43) Pub. Date: Feb. 1, 2018

(54) AUGMENTED REALITY HEAD-UP DISPLAY ROAD CORRECTION

(71) Applicant: Panasonic Automotive Systems Company of America, Division of Panasonic Corporation of North America, PEACHTREE CITY, GA (US)

(72) Inventors: EDO OMANOVIC, FARMINGTON HILLS, MI (US); HENRY POPE, REDFORD, MI (US); WALTER NILL, DAVISON, MI (US)

(73) Assignee: Panasonic Automotive Systems Company of America, Division of Panasonic Corporation of North America

(21) Appl. No.: 15/661,495

(22) Filed: Jul. 27, 2017

Related U.S. Application Data
(60) Provisional application No. 62/368,724, filed on Jul. 29, 2016.

(51) Int. Cl. G02B 27/01; G01C 21/36

(52) U.S. Cl. CPC G02B 27/0179; G01C 21/365; G02B 2027/0183; G02B 2027/0141; G02B 2027/0181

(57) ABSTRACT

A head up display arrangement for a motor vehicle includes an image source providing images. Optics are then positioned to provide a reflection of the images such that the virtual images are perceived by a driver of the vehicle to be aligned with a road that is visible through a windshield of the vehicle. A force-detecting device detects a magnitude of a force exerted on the driver in a lateral direction from turning of the vehicle. An electronic processor adjusts, based on the magnitude of the force exerted on the driver, the virtual images and/or a position of the HUD Optics.

### CROSS-REFERENCED TO RELATED APPLICATIONS

This application claims benefit of U.S. Provisional Application No. 62/368,724 filed on Jul. 29, 2016, which the disclosure of which is hereby incorporated by reference in its entirety for all purposes.

### FIELD OF THE INVENTION

The disclosure relates to a head up display (HUD) in a motor vehicle.

### BACKGROUND OF THE INVENTION

Automotive head up displays (HUDs) are typically designed to project a virtual image that appears to be in front of the windshield. This distance ahead of the driver's eye point is set in the design of the instrument. It is significant that the image be beyond the distance of the point at which refocusing on the image is not required. This provides an additional safety margin over conventional instruments by keeping the drivers eyes focused on the road ahead.

### SUMMARY

For a driver to truly experience augmented reality from a HUD, the image needs to appear to the driver to be aligned with the road ahead (the road behind the HUD image). The present invention may provide a cost effective solution to properly align the augmented reality HUD virtual image with the road behind it.

Augmented Reality HUDs require the virtual image to line up with what is in front of the driver to work properly. Instead of using expensive driver monitoring cameras, other sensors can be implemented to keep the image properly aligned with the road ahead.

In one embodiment, the invention comprises a head up display arrangement for a motor vehicle, including an image source providing graphics. A mirror is positioned to provide a reflection of the images off the windshield such that the virtual images are perceived by a driver of the vehicle to be aligned with a road that is visible through a windshield in front of the vehicle. A force-detecting device detects a magnitude of a force exerted on the driver in a lateral direction from turning of the vehicle. An electronic processor adjusts, based on the magnitude of the force exerted on the driver, the virtual images and/or a position of the mirror. This then maintains the alignment of the image over the road.

In another embodiment, the invention comprises a head up display method for a motor vehicle, including providing virtual images. A reflection of the virtual images is provided such that the virtual images are perceived by a driver of the vehicle to be aligned with a road that is visible through a windshield of the vehicle. A magnitude of a force exerted on the driver in a lateral direction from turning of the vehicle is detected, and/or an orientation of a body of the vehicle is detected. The virtual images and/or a position of the image are adjusted dependent upon the detecting step.

In yet another embodiment, the invention comprises a head up display arrangement for a motor vehicle including an image source. The optics are positioned to provide a reflection of the images such that the virtual images are perceived by a driver of the vehicle to be aligned with a road that is visible through a windshield of the vehicle. A direction-detecting device detects an orientation of a body of the vehicle. An electronic processor adjusts, based on the orientation of the body of the vehicle, the virtual images and/or a position of the mirror.

### BRIEF DESCRIPTION OF THE DRAWINGS

A better understanding of the present invention will be had upon reference to the following description in conjunction with the accompanying drawings.

FIG. 1a is an example augmented reality image misaligned with the actual road behind it due to the driver being pulled rightward when the vehicle is turning left.

FIG. 1b is the example augmented reality image of FIG. 1a with compensation for the misalignment according to one embodiment of a correction method of the invention.

FIG. 2a is an example augmented reality image misaligned with the actual road behind it when the vehicle has hit a bump in the road.

FIG. 2b is the example augmented reality image of FIG. 2a with compensation for the misalignment according to another embodiment of a correction method of the invention.

FIG. 3 is a block diagam of one example embodiment of an automotive head up display arrangement of the present invention.

FIG. 4 is a flow chart of one embodiment of a head up display method of the present invention for a motor vehicle.

### DETAILED DESCRIPTION OF THE PREFERRED EMBODIMENTS

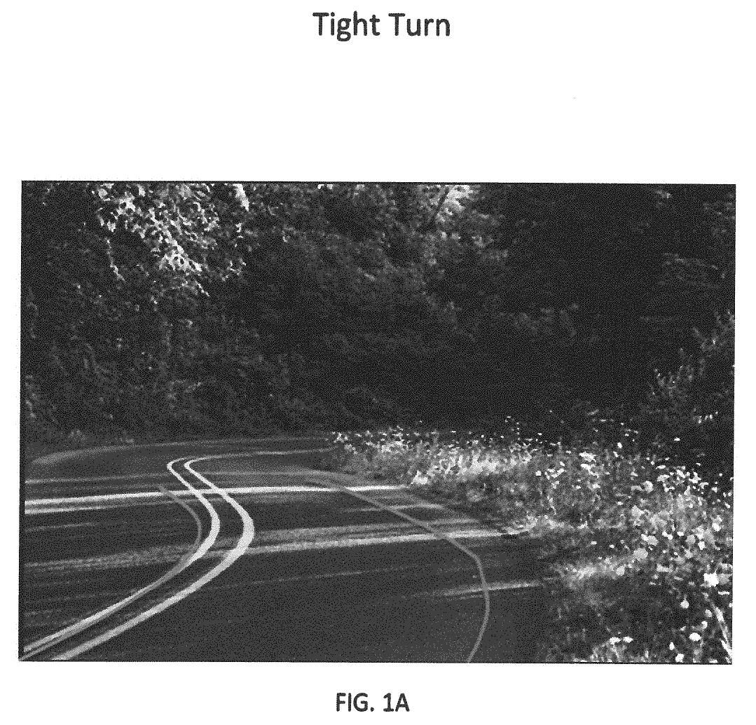

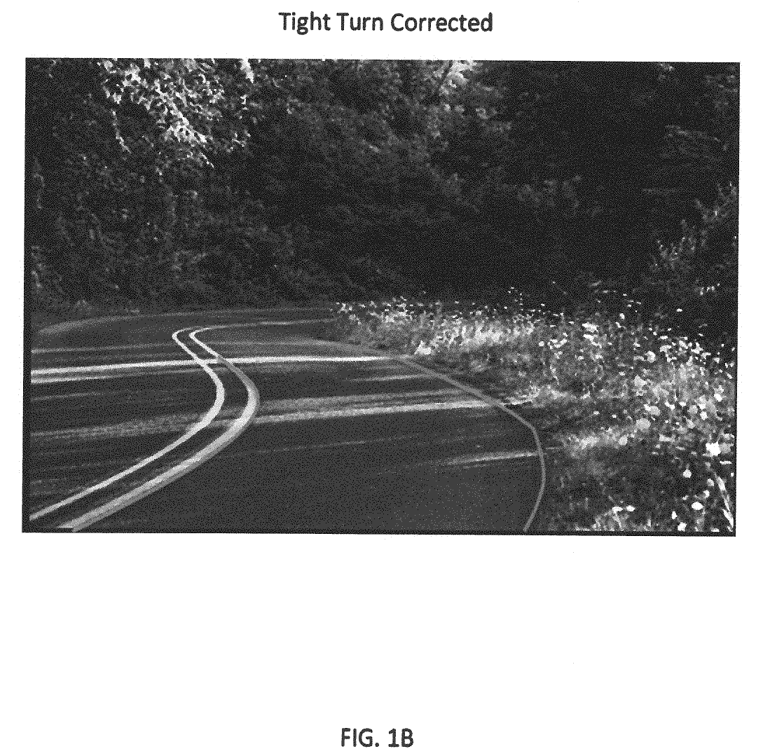

While turning left the driver is naturally shifted over to the right in his seat. This causes the virtual image to appear slightly to the left of the intended position, leading to misalignment of the virtual image with the road behind it, as shown in FIG. 1a. The tighter the turn, the more force the driver will experience, and the greater the gap between the intended position and actual position of the virtual image.

To realign the HUD virtual image with the road behind it, a gyroscope or accelerometer may detect the amount of force being exerted on a driver during a turn, and the required amount of shifting of the virtual image may be calculated based on the detected force. The virtual image may be adjusted accordingly, as shown in FIG. 1b. The augmented reality lines may be realigned with either software or a motor that adjusts a mirror of the HUD to make the correction. The position of the mirror may be adjusted to thereby shift the virtual images in a same direction as the detected force exerted on the driver. When the virtual images are perceived by a driver of the vehicle to be aligned with the road, the virtual borders of the lane that the vehicle is driving in are superimposed on the actual borders of the lane that the vehicle is driving in, as shown in FIG. 1b.

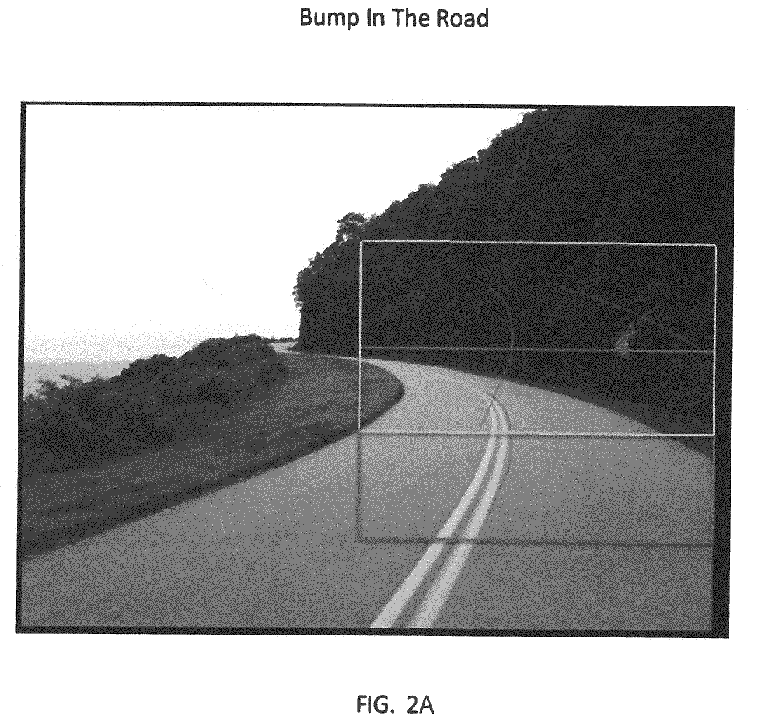

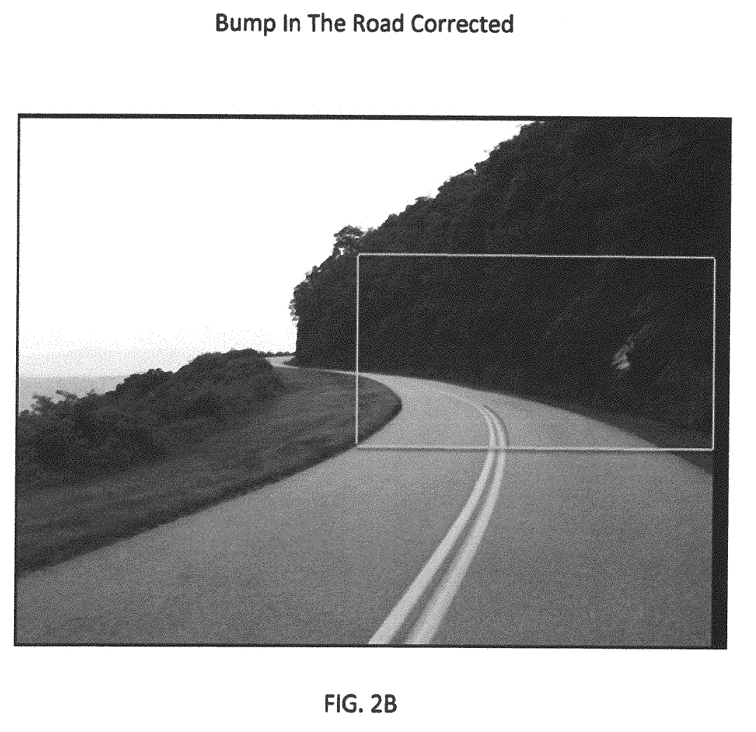

FIG. 2a is another example augmented reality image misaligned with the actual road behind it when the vehicle has been jarred, such as by a chuckhole or a bump in the road. Assume the blue box is the virtual image of the HUD. Upon being jarred, the front end of the vehicle is lifted off of the road, which in turn lifts the virtual image relative to the view of the actual road behind it. The orange box is the virtual image immediately after the jarring event. The information in the orange box at this time is inaccurate and completely useless to the driver. The output of a gyroscope may be provided to the HUD to inform the HUD about which directions are the upward direction and/or the downward direction. The software may then clip out the inaccurate virtual road lines from the orange box, as shown in FIG. 2b, which is the example augmented reality image of FIG. 2a with compensation for the misalignment. During this event of short time duration, the viewer views less information about the road (since the virtual road lines are much shorter), but the information that is displayed is accurate. As is evident from a comparison of FIGS. 2a-b, a first portion of the virtual images may be deleted, and a second portion of the virtual images may be vertically shifted.

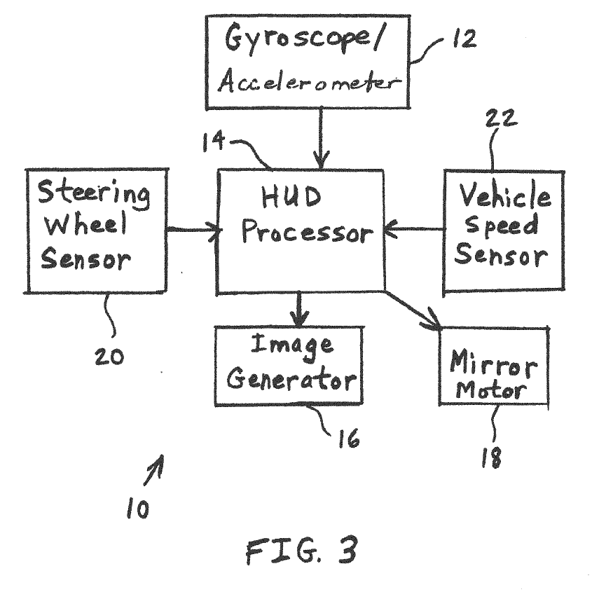

FIG. 3 is a block diagam of one example embodiment of an automotive head up display arrangement 10 of the present invention including a gyroscope/accelerometer 12, a HUD processor 14, an image generator 16, a mirror actuator 18, an optional steering wheel sensor 20, and an optional vehicle speed sensor 22. During use, gyroscope/accelerometer 12 may sense forces on the driver in a lateral direction (such as from turning) or movements of the vehicle body in vertical directions (such as from hitting a chuckhole or bump). Alternatively, steering wheel sensor 20 and vehicle speed sensor 22 may provide data to processor 14 that is indicative of lateral forces on the driver from turning. In response to the sensing of forces or movements that cause the virtual image to be misaligned with the actual road in the driver's perception, processor 14 may adjust the virtual image via image generator 16 to correct the misalignment, or may change the orientation of an image-reflecting mirror by sending control signals to motor 18 to correct the misalignment.

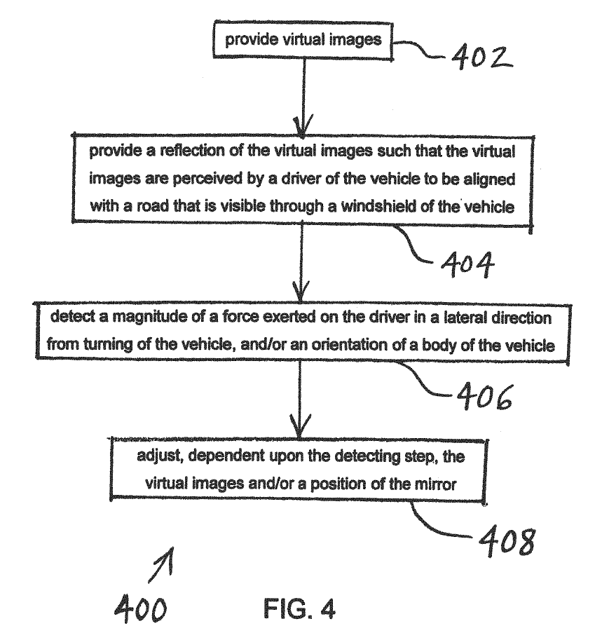

FIG. 4 illustrates one embodiment of a head up display method 400 of the present invention for a motor vehicle. In a first step 402, virtual images are provided. For example, image generator 16 may produce a virtual image in the form of a light field based on a signal from HUD processor 14.

Next, in step 404, a reflection of the virtual images is provided such that the virtual images are perceived by a driver of the vehicle to be aligned with a road that is visible through a windshield of the vehicle. For example, a mirror may reflect the light field, and the reflected light field may be further reflected off of a windshield of the vehicle such that the light field appears to the driver to be a virtual image superimposed over the road ahead. HUD processor 14 and image generator 16 may produce the virtual image such that the virtual image as seen by the driver appears to have lane boundaries which are superimposed over and/or aligned with the actual lane markings whether such actual lane markings are visible to the driver or not. The exact locations of the lane markings may be stored in memory and retrieved based upon the global position coordinates of the vehicle as determined by a GPS system.

In a next step 406, a magnitude of a force exerted on the driver in a lateral direction from turning of the vehicle, and/or an orientation of a body of the vehicle is detected. For example, gyroscope/accelerometer 12 may sense forces on the driver in a lateral direction (such as from turning) or movements of the vehicle body in vertical directions (such as from hitting a chuckhole or bump). Alternatively, steering wheel sensor 20 and vehicle speed sensor 22 may provide data to processor 14 that is indicative of lateral forces on the driver from turning.

In a final step 408, the virtual images and/or a position of the mirror is adjusted dependent upon the detecting step. For example, processor 14 may adjust the virtual image via image generator 16 to correct the misalignment, or may change the orientation of an image-reflecting mirror by sending control signals to motor 18 to correct the misaliglinent. The invention may have been described as including a gyroscope. However, in another embodiment, an accelerometer may be used as a less expensive alternative to a gyroscope.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, cars, trucks, buses, rail, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A head up display arrangement for a motor vehicle, the arrangement comprising:
an image source configured to provide many and varied images;
a mirror or other optical elements positioned to provide a reflection of the images such that the virtual images are perceived by a driver of the vehicle to be aligned with a road that is visible through a windshield of the vehicle;
a force-detecting device configured to detect a magnitude of a force exerted on the driver in a lateral direction from turning of the vehicle; and
an electronic processor configured to adjust, based on the magnitude of the force exerted on the driver, at least one of:
the virtual images; and
a position of the mirror.

2. The head up display arrangement of claim 1 wherein the force-detecting device comprises an accelerometer.

3. The head up display arrangement of claim 1 wherein the adjusting comprises shifting the virtual images in a same direction as the detected force exerted on the driver.

4. The head up display arrangement of claim 1 wherein the mirror or other optical elements is positioned to provide a first reflection of the image, the windshield being positioned to receive the first reflection and provide a second reflection of the virtual image such that the second reflection is visible to a driver of the vehicle.

5. The head up display arrangement of claim 1 wherein the adjusting comprises adjusting a position of the mirror or other optical elements to thereby shift the virtual images in a same direction as the detected force exerted on the driver.

6. The head up display arrangement of claim 1 wherein the virtual images comprise virtual borders of a lane that the vehicle is driving in.

7. The head up display arrangement of claim 6 wherein when the virtual images are perceived by a driver of the vehicle to be aligned with the road, the virtual borders of the lane that the vehicle is driving in are superimposed on the actual borders of the lane that the vehicle is driving in.

8. A head up display method for a motor vehicle, the method comprising:
providing virtual images;
providing a reflection of the virtual images such that the virtual images are perceived by a driver of the vehicle to be aligned with a road that is visible through a windshield of the vehicle;
detecting at least one of:
a magnitude of a force exerted on the driver in a lateral direction from turning of the vehicle; and
an orientation of a body of the vehicle; and
adjusting, dependent upon the detecting step, at least one of:
the virtual images; and
a position of the mirror,

9. The head up display method of claim 8 wherein the magnitude of the force is detected by an accelerometer.

10. The head up display method of claim 8 wherein the adjusting comprises shifting the virtual images in a same direction as the detected force exerted on the driver.

11. The head up display method of claim 8 wherein the reflection comprises a first reflection, the method further comprising providing a second reflection of the virtual image such that the second reflection is visible to a driver of the vehicle.

12. The head up display method of claim 8 wherein the adjusting comprises adjusting a position of the mirror or other optical elements to thereby shift the virtual images in a same direction as the detected force exerted on the driver.

13. The head up display method of claim 8 wherein the virtual images comprise virtual borders of a lane that the vehicle is driving in.

14. The head up display method of claim 13 wherein when the virtual images are perceived by a driver of the vehicle to be aligned with the road, the virtual borders of the lane that the vehicle is driving in are superimposed on the actual borders of the lane that the vehicle is driving in.

15. A head up display arrangement for a motor vehicle, the arrangement comprising:
an image source configured to provide images;
a mirror or other optical elements positioned to provide a reflection of the images such that the virtual images are perceived by a driver of the vehicle to be aligned with a road that is visible through a windshield of the vehicle;
a direction-detecting device configured to detect an orientation of a body of the vehicle; and
an electronic processor configured to adjust, based on the orientation of the body of the vehicle, at least one of:
the virtual images; and
a position of the mirror.

16. The head up display arrangement of claim 15 wherein the direction-detecting device comprises a gyroscope.

17. The head up display arrangement of claim 15 wherein the adjusting comprises deleting a first portion of the virtual images and vertically shifting a second portion of the virtual images.

18. The head up display arrangement of claim 15 wherein the mirror or other optical elements is positioned to provide a first reflection of the virtual image, the windshield being positioned to receive the first reflection and provide a second reflection of the virtual image such that the second reflection is visible to a driver of the vehicle.

19. The head up display arrangement of claim 15 wherein the adjusting comprises adjusting a position of the mirror or other optical elements to thereby shift at least a portion of the virtual images in a vertical direction.

20. The head up display arrangement of claim 15 wherein the virtual images comprise virtual borders of a lane that the vehicle is driving in, and wherein when the virtual images are perceived by a driver of the vehicle to be aligned with the road, the virtual borders of the lane that the vehicle is driving in are superimposed on the actual borders of the lane that the vehicle is driving in.
